(19) United States
(12) Patent Application Publication
(10) Pub. No.: US 2015/0207642 A1
(43) Pub. Date: Jul. 23, 2015

(54) Virtual Secure Document Review Rooms

(71) Applicant: Online Document Managment, LLC, Atlanta, GA (US)

(72) Inventors: Dan Bradbary, Fort Lauderdale, FL (US); Karen Perkins, Fort Worth, TX (US)

(73) Assignee: Online Document Managment, LLC, Atlanta, GA (US)

(21) Appl. No.: 14/162,579

(22) Filed: Jan. 23, 2014

(51) Int. Cl. H04L 12/18

(52) U.S. Cl. CPC H04L 12/1822

(57) ABSTRACT

A computer-based system providing virtual secure document review rooms over a data network includes a first computer-based device wherein said first computer-based device is comprised within a computing cloud accessible across the data network and is configured with a data structure comprising a group associated with a group administrator and one or more rooms, each of which are associated with a room administrator, one or more documents, and one or more user. A second computer-based device is configured with a group administrator client in communication with the first device. A third computer-based device is configured with a room administrator client in communication with the first device. A fourth computer-based device is configured with a room user client in communication with the first device. A fifth computer-based device is configured with an administrator client in communication with the first device.

### BRIEF DESCRIPTION OF THE DRAWINGS

The apparatus is described with reference to the accompanying drawings. In the drawings, like reference numbers indicate identical or functionally similar elements. Additionally, the left-most digit(s) of a reference number identifies the drawing in which the reference number first appears.

FIG. 1 is an exemplary system embodying the present invention;

FIG. 2 is an exemplary server architecture that may be used by the system of the present invention;

FIG. 3 is an exemplary process for client access and room creation according to an embodiment of the present invention;

FIG. 4 is an exemplary login process for client access according to an embodiment of the present invention;

FIG. 5 illustrates the relationships vis-à-vis the group, the room data structure and the room users; and

FIG. 6 is a functional schematic of an exemplary computer-based device which may be used in the system of the present invention.

### DETAILED DESCRIPTION

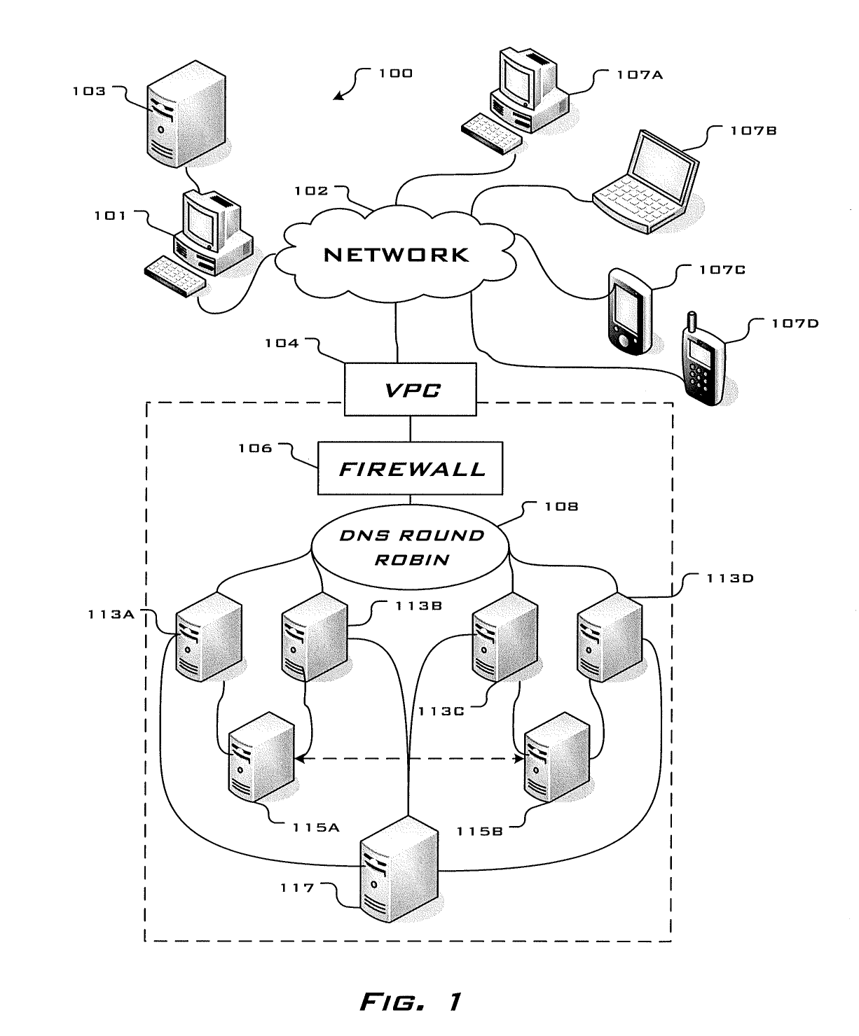

The various embodiments of the present invention and their advantages are best understood by referring to FIGS. 1 through 6 of the drawings. The elements of the drawings are not necessarily to scale, emphasis instead being placed upon clearly illustrating the principles of the invention. Throughout the drawings, like numerals are used for like and corresponding parts of the various drawings.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

This invention may be provided in other specific forms and embodiments without departing from the essential characteristics as described herein. The embodiments described above are to be considered in all aspects as illustrative only and not restrictive in any manner.

This system and method may be provided in other specific forms and embodiments without departing from the essential characteristics as described herein. The embodiments described above are to be considered in all aspects as illustrative only and not restrictive in any manner. The appended claims rather than the present description indicate the scope of the invention as may be construed according to applicable law.

In the following description, numerous details are set forth. It will be apparent, however, to one skilled in the art, that the system and method may be practiced without these specific details. In some instances, well-known structures and devices are shown in block diagram form, rather than in detail, in order to avoid obscuring the system and method.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “providing”, “forwarding”, “receiving”, “performing”, “comparing”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The functions of the system are performed on an apparatus comprising an interconnected collection of machines configured for performing the operations disclosed herein. This apparatus may be specially constructed for the required purposes, or it may comprise one or more general purpose computer systems selectively activated or reconfigured by a computer program stored memory. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, the system and method is not described with reference to any particular programming language. It will be appreciated that a variety of programming languages may be used to implement the teachings described herein.

Functions performed by the system may be provided as a computer program product, or software, that may include a machine-readable medium having stored thereon instructions, which may be used to program a computer system (or other electronic devices) to perform a process according to the system and method. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

Throughout the specification and claims, the following terms take the meanings explicitly associated herein, unless the context clearly dictates otherwise. The phrase “in one embodiment” as used herein does not necessarily refer to the same embodiment, although it may. Nor does the phrase “in another embodiment” necessarily refer to a different embodiment, although it may. Moreover, one or more embodiments may be combined to provide another embodiment, without departing from the scope or spirit of the invention. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

FIG. 1 illustrates one environment in which the present invention may operate. However, not all of these components may be required to practice the invention, and variations in the arrangement and type of the components may be made without departing from the spirit or scope of the invention. System 100 of FIG. 1 may be employed to enable client to request and use virtual secure document review rooms over a network.

As shown in the figure, system 100 in this embodiment comprises a first client device 101 in communication with an administrator database 103 which is configured with an administrator database, a network 102, a plurality of client 107-111 in communication with the network 102, which is in turn in communication with a virtual private cloud (“VPC”) 104.

The VPC 104 may also be understood as a “virtual private network,” or “virtual sub-network” and is a logical grouping of network devices on a network that makes the network devices appear to each other as if they are on a same physical network segment. The VPC 104 also provides security in that the VPC 104 is segmented logically from other networks, devices, servers, etc within the host network. Furthermore the VPC 104 provides network firewall rules that prevent intrusion and network traffic from entering the VPC 104. Within the VPC 104 multiple subnets are deployed one for each data center. Routes between the subnets allow each data center to communicate with other data centers. Access Control Lists are established to govern inbound and outbound communication with other subnets and the Internet. Security Groups define Firewall rules for groups of or specific machines. In one exemplary embodiment, the VPC 104 comprises one or more servers 113, 115, 117 that that provide the services requested of the system 100 as will be described in greater detail below.

In an embodiment in which multiple servers are employed, service requests from administrators or users may be distributed among the servers through a round-robin domain name system (“DNS”). In such an embodiment, one or more servers may be dedicated application servers 113a-d that are in communication with one or more database servers 117 and, preferably, one or more file servers 115a, b.

Client 101, 107a-d may include virtually any computing device capable of communicating over a network to send and receive information, including web requests for information from a server, messages to another computing device, or the like. The set of such devices may include devices that typically connect using a wired communications medium such as personal computers, multiprocessor systems, microprocessor-based or programmable consumer electronics, network PCs, or the like. The set of such devices may also include devices that typically connect using a wireless communications medium such as cell phones, smart phones, radio frequency (RF) devices, infrared (IR) devices, integrated devices combining one or more of the preceding devices, or virtually any mobile device. Similarly, client 101, 107a-d may be any device that is capable of connecting using a wired or wireless communication medium such as a PDA, POCKET PC, wearable computer, and any other device that is equipped to communicate over a wired and/or wireless communication medium.

Network 102 is configured to couple one client device 101, 107 with other client devices 101, 107 through the VPC 104. Network 102 is enabled to employ any form of computer readable media for communicating information from one electronic device to another. In one embodiment, network 102 may include the Internet.

Network 102 may also include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Network 102 may further employ a plurality of wireless access technologies including, but not limited to, 2nd (2G), 3rd (3G) generation radio access for cellular systems, Wireless-LAN, Wireless Router (WR) mesh, or the like. Access technologies such as 2G, 3G, and future access networks may enable wide area coverage for network devices, with various degrees of mobility. For example, network 102 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like.

Furthermore, remote computers and other related electronic devices could be remotely connected to either LANs or WANs via a modem and temporary telephone link. In essence, network 102 may include any communication method by which information may travel between one network device and another network device.

Additionally, network 102 may include communication media that typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as, but not limited to, twisted pair, coaxial cable, fiber optics, wave guides, and other wired media and wireless media such as, but not limited to, acoustic, RF, infrared, and other wireless media.

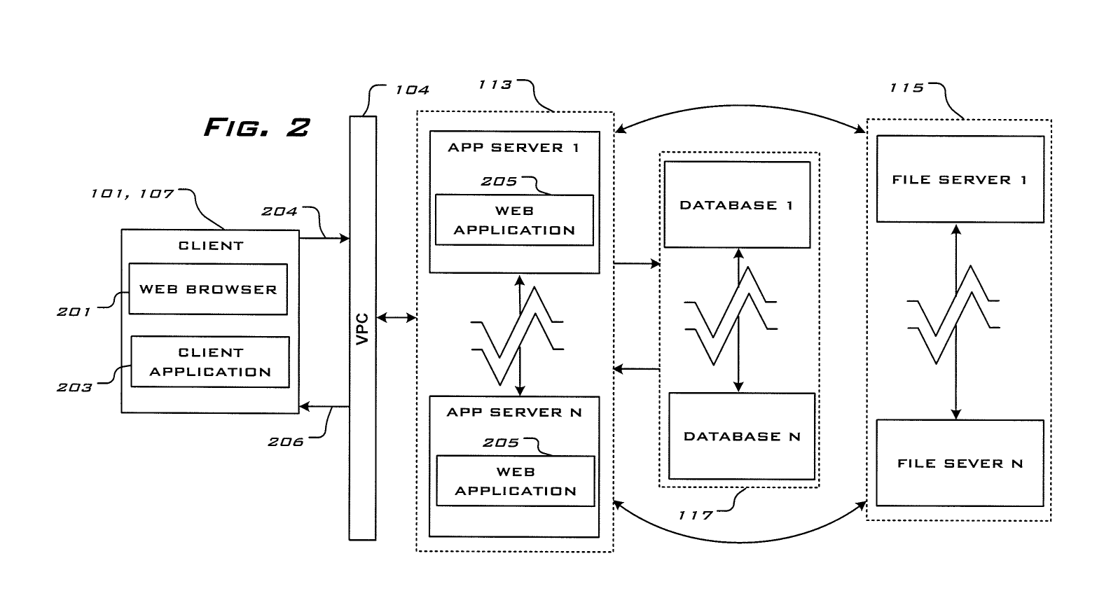

With reference to FIG. 2, client 101, 107a-d may include a web browser application 201 that is configured to enable an end-user to interact with other devices and applications over network 102. In one embodiment, user device 107 includes browser 201 that enables user device 107 to access information maintained by, and use services provided by, the VPC 104. A web browser 201 is an application that enables client 101, 107 to display and interact with text, images, and other information provided by servers. Web browser 201 may be configured to display web pages (e.g., by using hypertext transfer protocol (HTTP), extended markup language (XML), JavaScript, etc.). In an alternative embodiment, client device 101, 107 initiates service requests without use of a web browser 201.

In addition, client 101, 107a-d may also include a client application 203 that is configured to manage various actions such as enabling communications over network 102 to request, join, and/or participate in one or more virtual document review rooms, or to establish or monitor the activities within virtual document review rooms, depending on the type of client 101, 107, and the client's credentials. In one embodiment, a client may be an admin client 101 or a user client 107. A user client 107 may be a “group admin,” a “room admin,” or a “room user.”

Application server 113 may provide one or more services (e.g., database services, systems management services, network monitoring services, transactional services, webpage viewing services, etc.) to admin and user clients 101, 107. Application server 113 may be a front end server (e.g., that provides an interface to client 101, 107) and/or a back end server. Through the application server 113, users of clients 101, 107 may request data, initiate actions, receive information, etc., via application service requests 204.

In one embodiment, application server 113, which may be one or more application servers, is a web application server, and is configured with a web application 205 that receives data entered from the client 101, 107 through an application service request 204. Based on the contents of the application service request 204, application server 113 may determine that web application 205 should perform one or more actions, after which application server 113 may return an application service response 206 to the client 101, 107. For example, the web application 205 provides an application response 206 comprising data information retrieval and display services. Though only a single web application 205 is shown, application server 113 may include multiple web applications and/or other services.

Application servers 113 are in communication with database server 117 which may comprise one or more database servers 117 configured to store data relating to virtual document review rooms, for example, admin or user access credentials, documents and the virtual document review rooms with which the documents are associated, room and document access events and times. Web application 205 is configured with instructions which may retrieve such data, and, to the extent such data may be access by a client 101, 107 depending on client credentials, provide the data to the file server(s) 115. File servers are configured to provide access to designated shared information in responses 206 to requests 204 by the client 101, 107 through the web application 205.

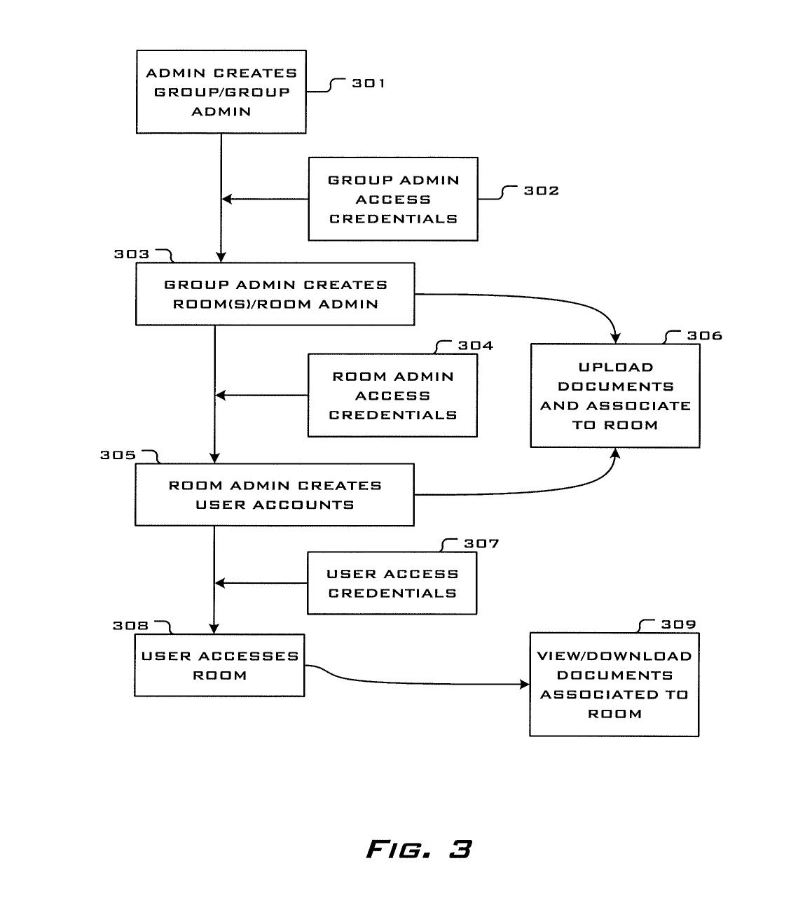

With reference now to FIG. 3, when a new account virtual data room account is requested, an Admin 101 will first log into the V-Rooms system. After the Admin 101's login is authenticated, the Admin 101 will navigate to the Group Management screen and create a new group for the account 301. Then the Admin 101 then creates a Group Admin user account who will have authority to manage the created group. This is typically the primary contact with the account. As the Group Admin is created 301, the Admin 101 will have the system send an email to the Group Admin with their login credentials.

The Admin 101 will continue to monitor each new account/group's activities through system audit reports. If requested and authorized by the Group Admin, the Admin 101 may perform other functions for the Group Admin such as creating new rooms for the group, creating additional users, uploading files, and running reports, but these activities are typically reserved for the Group and Room Administrators.

Once a Group Admin receives their login credentials, they will log into the V-Rooms system 302. After the Group Admin's login is authenticated, the Group Admin will navigate to the Group Management screen and create a new room for their group 303. Then the Group Admin can create Room Admins 303 to assist with the administration of the newly created room, and/or the Group Admin can create a folder structure and upload files into the newly created room 306. Once the room is populated with one or more files, the Group Admin can also create Users to share the documents with. As the Group Admin creates new Room Admins and/or Users, the Group Admin will have the system send an email to the new Room Admins and/or Users with their login credentials. The Group Admin will continue to monitor their group's activities through the system's audit reports.

Once a Room Admin receives their login credentials, they will log into the V-Rooms system 304. After the Room Admin's login is authenticated, the Room Admin will navigate to the Admin Screens they have been authorized to use. This could include Room Management, Folder/File Management, User Management and Reporting functions. If the Room Admin has the appropriate authority they can create a folder structure and upload files into the newly created room 306, can create Users 305 to share the documents with, and can continue to monitor the room's activities through the system's audit reports. As the Room Admin creates new Users, the Room Admin will have the system send an email to the new Users with their login credentials 307.

Once a User receives their login credentials, they will log into the V-Rooms system 307. After the User's login is authenticated, the User will navigate to the User Interface Screens they have been authorized to use, view the available files, download or print files (if permitted), and view a listing of available files 309.

Once a project is complete or an account is ready to close, the Admin 101 may also be asked to archive a room(s) prior to deleting a room(s).

Admin 101s, Group Admins, Room Admins and Room Users will sign off the system at the completion of their tasks on a daily basis. If any of the users are inactive on the system for more than 30 minutes, the system will automatically sign the user off. The user would then be required to login and authenticate again before regaining access to the system.

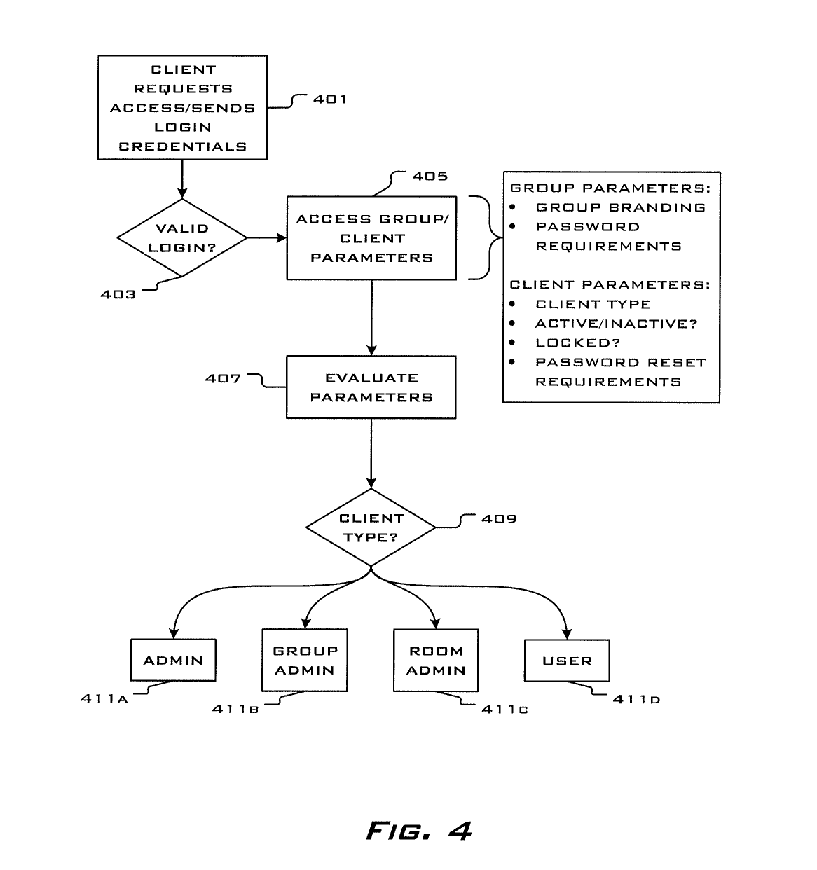

FIG. 4 illustrates an exemplary user authentication procedure. When an individual wishes to access the system, they will connect to the internet via web browser 201 and navigate to a web page that contains a system login. The user will type in the username and password they have been provided into a login area and the browser 201 will send their username and password (encrypted) through the internet to the VPC 401. The web application 205 will first determine if the username exists, and then determine if the password provided with the username is correct 403.

If the username or password is incorrect, the user will be sent a message to their browser window indicating that either the username or password they provided is invalid. The user may at that time reattempt the login/user authentication. If the group that the user is trying to access has established a limitation on the number of invalid login attempts, additional invalid login attempts in succession may cause the web application to lock the user's account.

If the username and password are correct, the web application 205 will retrieve parameters from the user's account that is being logged into along with parameters from the associated group. 405 User parameters would include the user type, whether or not the user account is active, whether or not the user account is locked, and whether or not the user's password needs to be reset (expiration requirement). If two-factor authentication is required for the group, the user's security question and answer will also be retrieved. Additional group parameters would include the group's branding (colors and logo) and the password complexity requirements (if the user is required to reset their password).

Once the parameters are retrieved, if the user's account is flagged inactive or is locked, the user will be sent a message to their browser window indicating that their user account is locked or inactive. Reattempting to login will not produce any different results for the user. They user must at this time contact their Group Admin or one of our company's Admin 101s to request their account be unlocked or reactivated.

If the user's account is not flagged inactive and is not locked, the web application 205 will then determine if the user's password has expired or requires changing because of administrative reset. If the user's password has expired or requires changing, the user will be presented through their web browser with a password change screen. The old password will be required first, and then the new password must be entered and confirmed on the password change screen. The new password will be validated against the group's password complexity requirements (i.e. number of characters, capital and lower case letters, numbers and special character requirements).

Once the user's password is reset (if required), then the web application checks to see if 2-factor authentication is required. If 2-factor authentication is required and if the user has not previously set up their security question, they will first be prompted to establish a security question and answer. If 2-factor authentication is required and the user has previously set up their security question, the user will be presented through their web browser with their security question. The user will type the answer to their security question in the 2-factor authentication screen.

If the user does not correctly enter the answer for their security question, the user will be sent a message to their browser window indicating that they answer to their security question has been entered incorrectly. Until the user is able to provide the correct security question answer, they will not be allowed to proceed further, and must contact their Group Admin to reset their security question and/or answer. Once the user has correctly answered their security question, if required, then the web application 205 will route the user to the next appropriate screen in the system based on their user type. At the same time, the system evaluates the user's group and client parameters 407 and determines the user type associated with the user account, i.e., Admin 411a, group admin 411b, room admin 411c, or room user 411d.

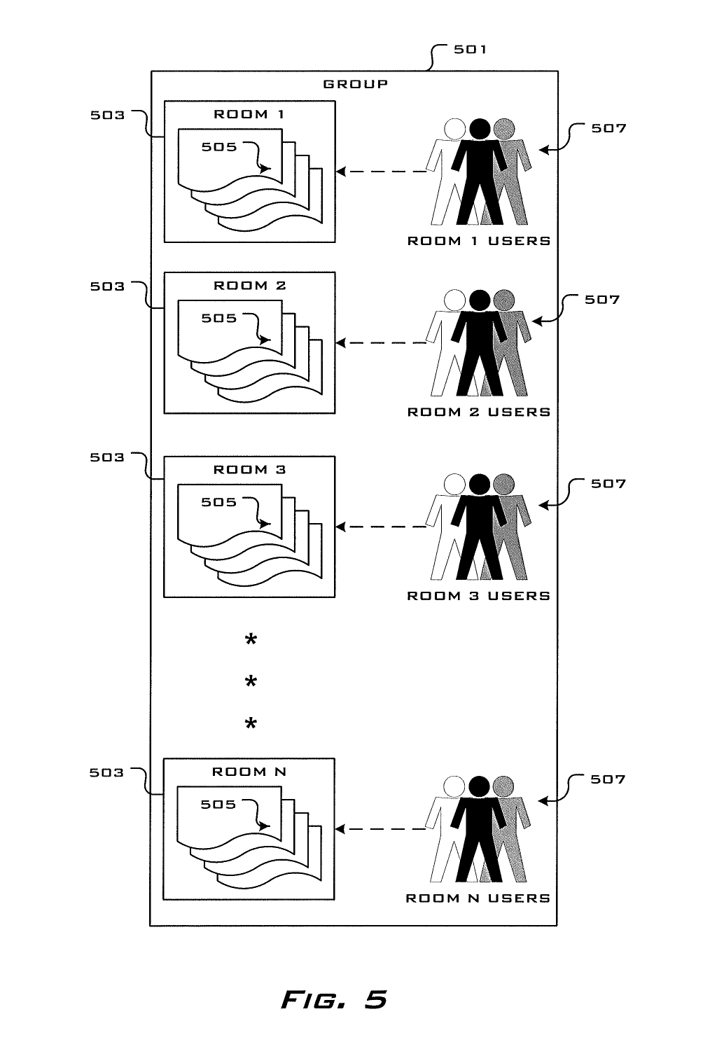

FIG. 5 illustrates exemplary group, room and room user relationships. A group 501 which may be an organization, e.g., a business or firm, may establish one or more rooms 503 with each of each are associated documents 505 (files) that pertain to a project. Accordingly, each room may be thought of as a project room. Users 507 that have a need to view or download a room's documents 505 are given access to the room 503.

In one embodiment, a Group Administrator 411b is given authority to perform several functions pertaining to group administration, for example, group management, room management, including room creation, document management, group and room user management, permissions policy creation and management and generation of various system administrative reports. Similarly, in one embodiment, a Room Administrator 411c may be given authority to perform several functions pertaining to room administration, for example, room management, document management, user management, including creation of user accounts, permissions policy creation and management, and generation of various room administration reports.

In one embodiment, the permissions policy function relates to establishing digital rights management associated with a group of documents within the room or with individual documents. Advantageously, permissions policies may be amended dynamically to accommodate room or user requirements. “Permissions,” as used herein encompass various functions a room user is permitted to perform with a given document. Exemplary permissions include, “open” which allows an accessed document to be opened after it has been saved on a room user's client device; “print” allows an accessed document to be printed after it is opened on a room user's client device; “save” allows an accessed document to be saved after it has been opened by a room user on a room user client device. In addition, the number of times a file may be opened or printed by a room user may be restricted. “Permission expiration” allows an expiry date to be defined in days, weeks, months or years after the document is accessed. Finally, permissions policies may include the ability to disable printing of documents by room users entirely.

In another embodiment, documents may be associated with a “watermark,” which may appear when the document is displayed on a client device or printed. The watermark may be defined by an group or room administrator to include pertinent document information, such as whether the document is confidential, the name of the user accessing the document, the date and time of access, and the internet protocol address from which the document was accessed, and any custom text an administrator may wish to add.

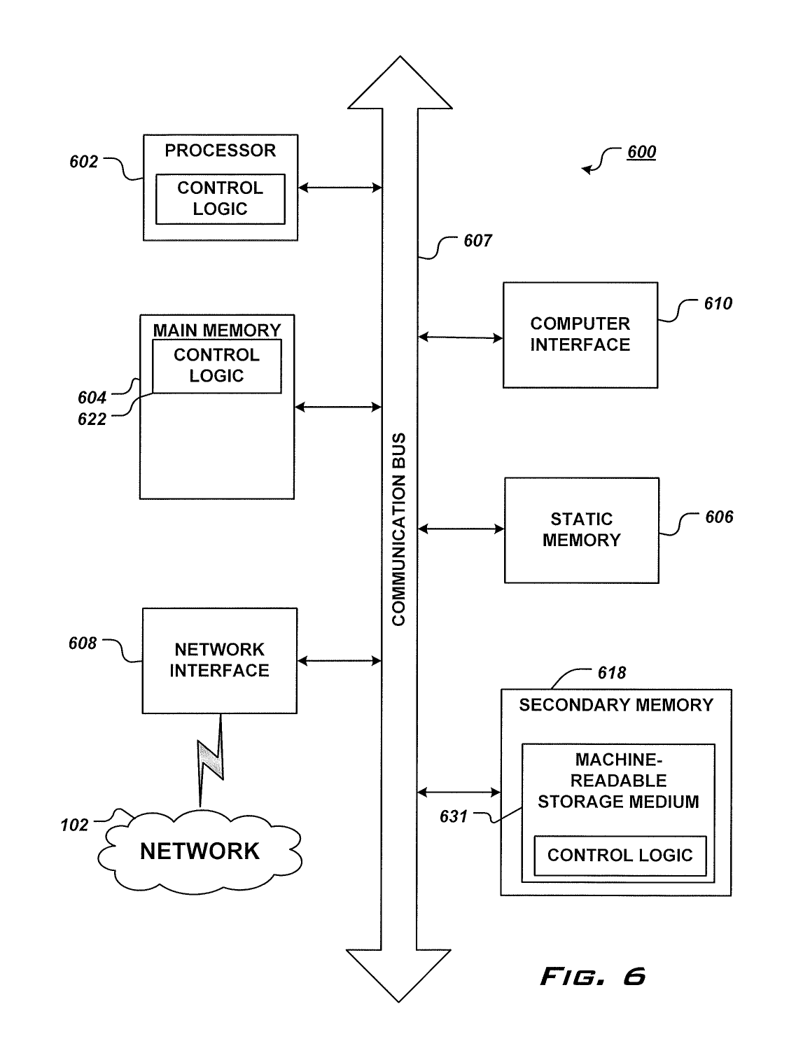

FIG. 6 illustrates a diagrammatic representation of a machine in the exemplary form of a computer system 600 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processor 602 and a main memory 604 (e.g., read-only memory (ROM), flash memory, dynamic random access memory (DRAM) such as synchronous DRAM (SDRAM) or Rambus DRAM (RDRAM), etc. Computer system 600 may also include a static memory 606 (e.g., flash memory, static random access memory (SRAM), etc.), and a secondary memory 618 (e.g., a data storage device), which communicate with each other via a communication bus 607.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute the control logic 622 for performing the operations and steps discussed herein.

The computer system 600 may further include a network interface device 608. The computer system 600 also may include a computer interface 610 comprising output device, such as a display (e.g., touch-responsive screen, a light-emitting diode (LED) display, a liquid crystal display (LCD) or a cathode ray tube (CRT)), and an input device (e.g., a keyboard, or microphone).

The secondary memory 618 may include a machine-readable storage medium (or more specifically a computer-readable storage medium) 631 on which is stored one or more sets of instructions (e.g., control logic 622) embodying any one or more of the methodologies or functions described herein. The control logic 622 may also reside, completely or at least partially, within the main memory 604 and/or within the processing device 602 during execution thereof by the computer system 600, the main memory 604 and the processing device 602 also constituting machine-readable storage media. The control logic 622 may further be transmitted or received over a network 102 via the network interface device 608.

The machine-readable storage medium 631 may also be used to store the web application, and any data storage structures for storing documents, administrative information, room information and user information, and/or a software library containing methods that call such web application or data storage structures. While the machine-readable storage medium 631 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the system and method. The term “machine-readable storage medium” shall accordingly be taken to include, but not be limited to, solid-state memories, and optical and magnetic media.

Control logic 622 (also called computer programs or software) is stored in the main memory and/or secondary memory. Control logic 622 can also be received via the communications interface. Such control logic, when executed, enables the computer system to perform certain features of the system and method as discussed herein. In particular, the control logic, when executed, enables a control processor to perform and/or cause the performance of features of the system and method. Accordingly, such control logic 622 represents controllers of the computer system.

The processor 602, and the processor memory, may advantageously contain control logic 622 or other substrate configuration representing data and instructions, which cause the processor to operate in a specific and predefined manner as, described hereinabove. The control logic 622 may advantageously be implemented as one or more modules. The modules may advantageously be configured to reside on the processor memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. Control logic 622 may be installed on the memory using a computer interface coupled to the communication bus which may be any suitable input/output device. The computer interface may also be configured to allow a user to vary the control logic, either according to pre-configured variations or customizably.

The control logic 622 conventionally includes the manipulation of data bits by the processor and the maintenance of these bits within data structures resident in one or more of the memory storage devices. Such data structures impose a physical organization upon the collection of data bits stored within processor memory and represent specific electrical or magnetic elements. These symbolic representations are the means used by those skilled in the art to effectively convey teachings and discoveries to others skilled in the art.

The control logic 622 is generally considered to be a sequence of processor-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for processor operations, and that these terms are merely conventional labels applied to physical quantities that exist within and during operation of the computer.

It should be understood that manipulations within the processor are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the processor or computers.

It should also be understood that the programs, modules, processes, methods, and the like, described herein are but an exemplary implementation and are not related, or limited, to any particular processor, apparatus, or processor language. Rather, various types of general purpose computing machines or devices may be used with programs constructed in accordance with the teachings described herein.

As described above and shown in the associated drawings, the present invention comprises a system and method for providing virtual secure document review rooms. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A computer-based system providing virtual secure document review rooms over a data network, said system comprising:
a first computer-based device configured with a data structure comprising a group, said group being associated with a group administrator and one or more rooms, and each of said rooms associated with a room administrator, one or more documents, and one or more user;
a second computer-based device configured with a group administrator client in communication with said first device;
a third computer-based device configured with a room administrator client in communication with said first device;
a fourth computer-based device configured with a room user client in communication with said first device; and
a fifth computer-based device configured with an administrator client in communication with said first device; and
wherein said administrator client is configured to allow creation of a group and to allow designation of said group administrator; and
wherein said group administrator client is configured to allow creation of said one or more rooms and to allow designation of said room administrator associated with each of said one or more rooms; and
wherein said room administrator is configured to allow association of said one or more documents to said one or more rooms and to allow the designation of one or more users associated with said one or more rooms; and
wherein said first computer-based device is comprised within a computing cloud accessible across said data network.
